(19) United States
(12) Patent Application Publication
(10) Pub. No.: US 2014/0063324 A1
(43) Pub. Date: Mar. 6, 2014

(54) WIDE ANGLE LENS MODULE AND REAR VIEW CAMERA HAVING THE SAME

(71) Applicant: SAMSUNG ELECTRO-MECHANICS CO., LTD., Suwon (KR)

(72) Inventors: Tae Young KIM, Suwon (KR); Bok Sun An, Suwon (KR)

(73) Assignee: SAMSUNG ELECTRO-MECHANICS CO., LTD., Suwon (KR)

(21) Appl. No.: 13/672,090

(22) Filed: Nov. 8, 2012

(30) Foreign Application Priority Data
Sep. 6, 2012 (KR) 10-2012-0098831

(51) Int. Cl. H04N 5/238; H04N 5/225; G02B 17/08

(52) U.S. Cl. 348/340; 359/732; 348/369; 348/E05.04; 348/E05.028; 348/E05.03

(57) ABSTRACT

There is provided a wide angle lens module including: a first lens having negative refractive power; a second lens having positive refractive power and at least one first reflection surface; and a third lens having the positive refractive power and at least one second reflection surface.

### CROSS-REFERENCE TO RELATED APPLICATIONS

This application claims the priority of Korean Patent Application No. 10-2012-0098831 filed on Sep. 6, 2012, in the Korean Intellectual Property Office, the disclosure of which is incorporated herein by reference.

### BACKGROUND OF THE INVENTION

1. Field of the Invention

The present invention relates to a wide angle lens module and a rear view camera having the same, and more particularly, to a wide angle lens module capable of being easily mounted and cheaply produced, and a rear view camera having the same.

2. Description of the Related Art

A camera has been mainly used in vehicles as a unit for providing an image of the view to the front or rear of the vehicle.

For example, a rear view camera may be installed in a rear portion of a vehicle (in a trunk cover or a rear bumper) in order to image objects to the rear of the vehicle and provide image information to a driver. This rear view camera may provide the driver with images of objects that are not visible at the time of reversing the vehicle, so as to reduce the probability of collision between the vehicle and the object.

The rear view camera as described above includes a wide angle lens module having a relatively wider viewing angle as compared to a general lens module so as to provide a rear view having a wide range to the driver.

However, in this wide angle lens module, since a distortion phenomenon due to characteristics of the wide angle lens may be generated, a portion (particularly, a lower portion of the rear view) of the image that the driver tries to view may be significantly distorted.

Due to the above-mentioned reason, the rear view camera according to the related art adopts a method in which only important images from the images imaged by software are edited, or a method of fixing the wide angle lens module with a bracket so as to allow the wide angle lens module to image a view to the rear of the vehicle.

However, in the former method, since only portion of the captured image is used, the wide angle lens module is required to be large, and in the latter, since installation environments are different according to varying vehicle designs, there are many limitations in installation according to the design of the vehicle.

Meanwhile, although not directly related to the rear view camera, as related art of using a reflection lens, there are provided the following Related Art Documents.

### RELATED ART DOCUMENT

KR2005-009679 A
KR2009-081057 A

### SUMMARY OF THE INVENTION

An aspect of the present invention provides a wide angle lens module capable of being easily mounted, regardless of a vehicle design, as well as being cheaply produced, and a rear view camera having the same.

According to an aspect of the present invention, there is provided a wide angle lens module including: a first lens having negative refractive power; a second lens having positive refractive power and at least one first reflection surface; and a third lens having the positive refractive power and at least one second reflection surface.

The first lens may be formed of glass.

An object-side surface of the first lens maybe convex, and an image-side surface of the second lens may be concave.

The image-side surface of the second lens maybe convex.

The first reflection surface may form an angle of 55 degrees or more relative to a horizontal surface provided vertically with respect to an image-formation surface. The first reflection surface may satisfy Conditional Equation 1,

T1>(A1+d1*0.1)/0.76, Conditional Equation 1:

where T1 indicates a size of the first reflection surface, A1 indicates a size of a first surface of the second lens, and d1 indicates a distance from the first surface of the second lens to the first reflection surface.

An image-side surface of the third lens may be convex in the vicinity of an optical axis and become concave away from the optical axis.

At least one of an object-side surface and an image-side surface of the third lens may be a free-curved surface.

The first, second, and third lenses may satisfy Conditional Equation 2,

Θ1/2=(Θ2+Θ3), Conditional Equation 2:

where Θ1 indicates an angle between an optical axis of the first lens and a horizontal surface provided vertically with respect to an image-formation surface, Θ2 indicates an angle between the first reflection surface and the horizontal surface provided vertically with respect to the image-formation surface, and Θ3 indicates an angle between the second reflection surface and the horizontal surface provided vertically with respect to the image-formation surface.

Θ1 may be 35 degrees or more, and Θ2 may be 55 degrees or more.

According to another aspect of the present invention, there is provided a rear view camera including: a wide angle lens module including at least one reflection lens; an image sensor module converting images incident through the wide angle lens module into electrical signals; and a housing receiving the wide angle lens module and the image sensor module and having first and second opened surfaces provided in a non-parallel manner.

The lens module may include: a first lens having negative refractive power; a second lens including at least one first reflection surface; and a third lens including at least one second reflection surface.

The first lens may be mounted on the first opened surface, and the image sensor module may be mounted on the second opened surface.

The first lens may be formed of glass.

An object-side surface of the first lens may be convex, and an image-side surface of the second lens may be concave.

The image-side surface of the second lens may be convex.

The first reflection surface may form an angle of 55 degrees or more relative to a horizontal surface provided vertically with respect to an image-formation surface.

The first reflection surface may satisfy Conditional Equation 1,

T1>(A1+d1*0.1)/0.76, Conditional Equation 1:

where T1 indicates a size of the first reflection surface, A1 indicates a size of a first surface of the second lens, and d1 indicates a distance from the first surface of the second lens to the first reflection surface.

An image-side surface of the third lens may be convex in the vicinity of an optical axis and become concave away from the optical axis.

At least one of an object-side surface and the image-side surface of the third lens may be a free-curved surface.

The first, second, and third lenses may satisfy Conditional Equation 2,

Θ1/2=(Θ2+Θ3, Conditional Equation 2)

where Θ1 indicates an angle between an optical axis of the first lens and a horizontal surface provided vertically with respect to an image-formation surface, Θ2 indicates an angle between the first reflection surface and the horizontal surface provided vertically with respect to the image-formation surface, and Θ3 indicates an angle between the second reflection surface and the horizontal surface provided vertically with respect to the image-formation surface.

Θ1 may be 35 degrees or more, and Θ2 may be 55 degrees or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view of a wide angle lens module according to an embodiment of the present invention;

FIG. 2 is a diagram describing an angle of a reflective surface of the wide angle lens module shown in FIG. 1;

FIGS. 3 and 4 are views showing a modulation transfer function (MTF) curve and an aberration curve of the wide angle lens module shown in FIG. 1;

FIG. 5 is an outside view of a rear view camera according to an embodiment of the present invention; and

FIG. 6 is a cross-sectional view taken along line A-A of the rear view camera shown in FIG. 5.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

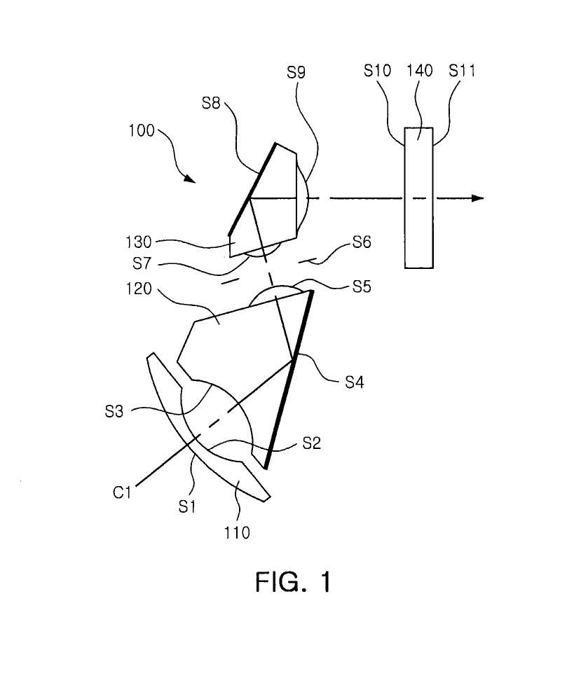

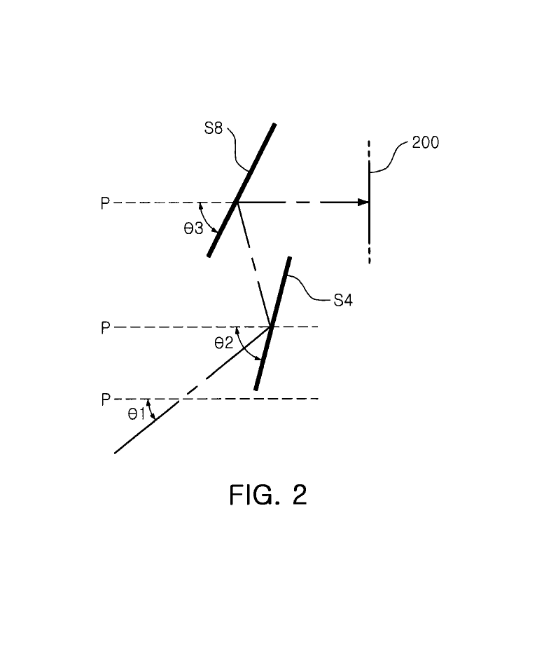

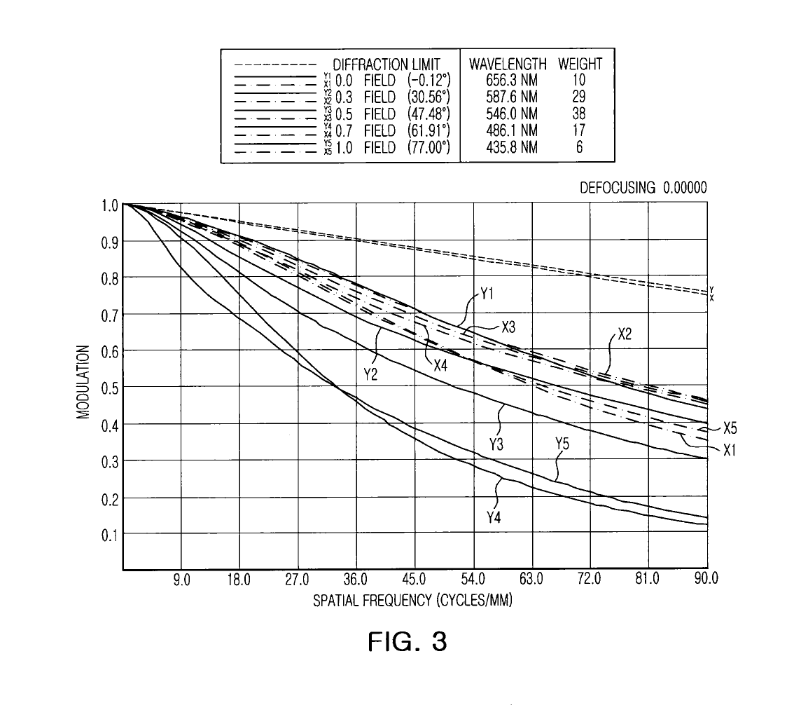

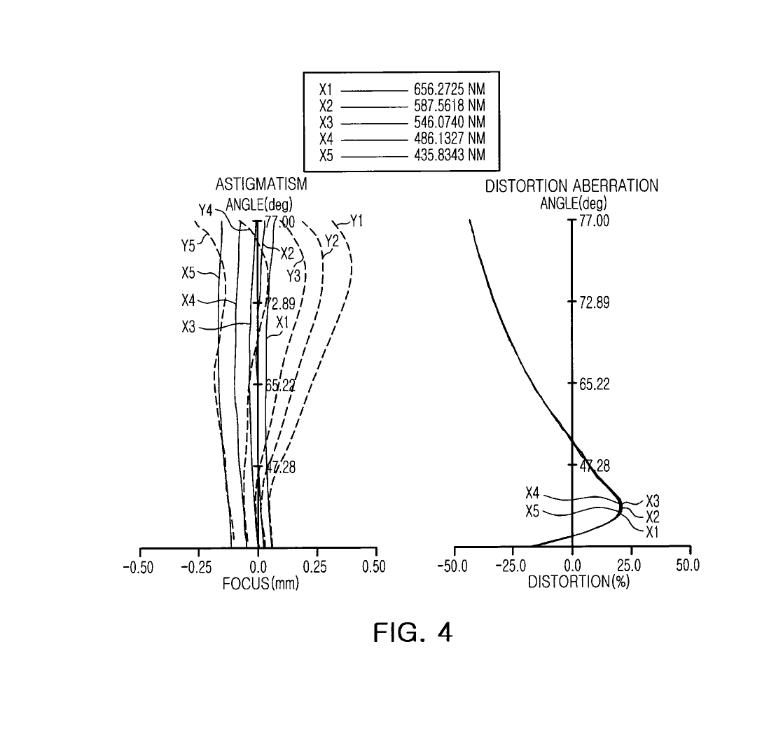

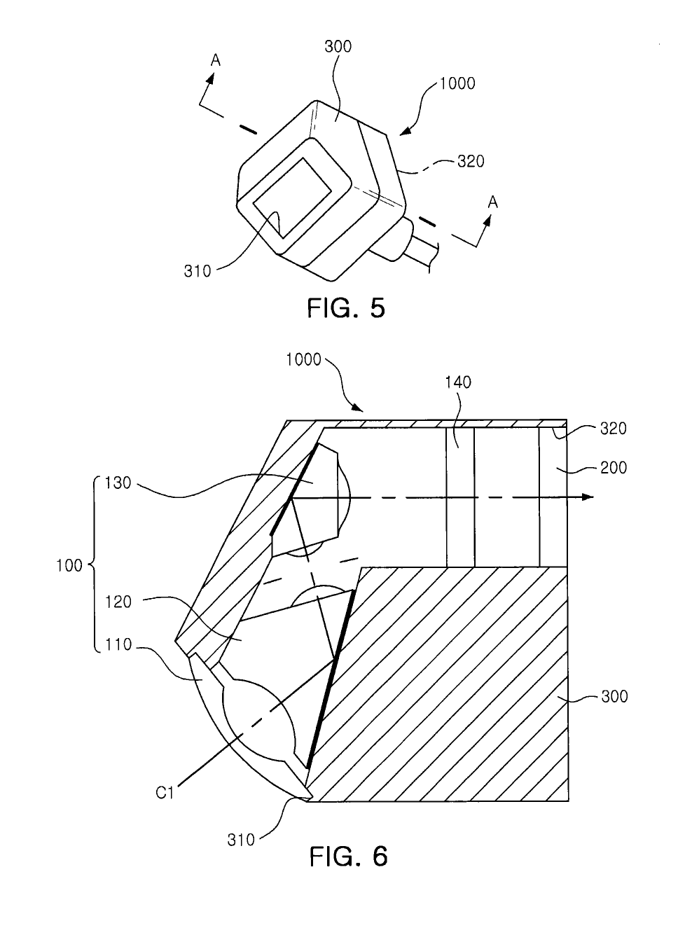

FIG. 1 is a configuration view of a wide angle lens module according to an embodiment of the present invention; FIG. 2 is a diagram describing an angle of a reflective surface of the wide angle lens module shown in FIG. 1; FIGS. 3 and 4 are views showing a modulation transfer function (MTF) curve and an aberration curve of the wide angle lens module shown in FIG. 1; FIG. 5 is an outside view of a rear view camera according to an embodiment of the present invention; and FIG. 6 is a cross-sectional view taken along the line A-A of the rear view camera shown in FIG. 5.

A wide angle lens module according to an embodiment of the present invention will be described with reference to FIGS. 1 through 4.

A wide angle lens module 100 according to an embodiment of the present invention may include a first lens 110, a second lens 120, and a third lens 130. In addition, the wide angle lens module 100 may selectively include an iris S6 and a filter member 140.

The first lens 100 may be disposed to be closest to an object side (or a subject) in the wide angle lens module 100. The first lens 110 may have generally negative refractive power and be formed of a glass. However, the material of the first lens 110 is not limited to plastic, but may be changed into glass or another optical material.

In the first lens 110, a first surface S1 may be convex, and a second surface S2 may be concave. Therefore, the first lens 110 may have a meniscus shape in which the first lens 110 is generally convex toward the object.

The first lens 110 may have an aspheric surface. For example, any one of the first and second surfaces S1 and S2 of the first lens 110 may be aspheric, or both of the first and second surfaces S1 and S2 of the first lens 110 may be aspheric. However, the first or second surface S1 or S2 of the first lens 110 is not necessarily limited to being aspheric, but both of the first and second surfaces S1 and S2 may be spherical, as needed.

The first lens 110 configured as described above may have a view angle of 140 degrees horizontally. However, the view angle of the first lens 110 is not limited to 140 degrees, but may be adjusted as needed. Meanwhile, the first lens 110 may have a refractive index of 1.6 or more.

The second lens 120 may be disposed behind the first lens 110, based on the subject, which is an object to be imaged.

The second lens 120 may have positive refractive power and be formed of a plastic material, similar to the first lens 110. However, the material of the second lens 120 is not limited to plastic, but may be changed into glass or another optical material.

In the second lens 120, a first surface S3 may be concave, and a second surface S5 may be convex. Here, at least one of the first and second surfaces S3 and S5 may be aspheric. For reference, in the present embodiment, both of the first and second surfaces S3 and S5 are aspheric and may have an aspheric shape satisfying Equation 1.

$$Z = \frac{{cr}^{2}}{1 + \sqrt{1 - ( 1 + k )} {c}^{2} {r}^{2}} + {Ar}^{4} + {Br}^{6} + {Cr}^{8} + {Dr}^{10} + {Er}^{12} + {Fr}^{14} + {Gr}^{16} + {Hr}^{18} + {Ir}^{20} \qquad [ Equation 1 ]$$

In Equation 1, c indicates curvature (1/r), k indicates a conic constant, r indicates a radius of curvature, and A to I sequentially indicate fourth to twentieth aspheric coefficients.

The second lens 120 may be a reflection lens or a prism lens. To this end, the second lens 120 may have at least one first reflection surface S4. The first reflection surface S4 may reflect light incident through the first surface S3 to the second surface S5. Here, the first reflection surface S4 may be a total reflection surface. More specifically, the first reflection surface S4 may be disposed between the first and second surfaces S3 and S5 so that total reflection may be performed.

The third lens 130 may be disposed behind the second lens 120, based on the subject, an object to be imaged. The third lens 130 may have positive refractive power and be formed of a plastic material. However, the material of the third lens 130 is not limited to plastic, but may be changed into glass or another optical material.

In the third lens 130, both of first and second surfaces S7 and S9 may be convex. Here, the second surface S9 may have a shape in which it is convex in the vicinity of an optical axis and becomes concave away from the optical axis. That is, the second surface S9 may have an inflection point at a position at which the surface does not cross the optical axis. However, the shape of the third lens 130 is not limited thereto.

At least one of the first and second surfaces S7 and S9 of the third lens 130 may be aspheric. More specifically, at least one of the first and second surfaces S7 and S9 of the third lens 130 may be a free-curved surface (here, the term “the free-curved surface” refers that a lens surface has an asymmetrical shape based on the optical axis). In addition, both of the first and second surfaces S7 and S9 of the third lens 130 may be free-curved surfaces, as needed. For reference, the first and second surfaces S7 and S9 of the third lens 130 may be free-curved surfaces satisfying Equation 2 in the present embodiment.

$$Z = \frac{{cr}^{2}}{1 + \sqrt{1 - ( 1 + k )} {c}^{2} {r}^{2}} + {\sum }_{j = 2}^{66} {C}_{j} {x}^{m} {y}^{n} \\ j = \frac{[ {( m + n )}^{2} + m + 3 n ]}{2} + 1 \qquad [ Equation 2 ]$$

In Equation 2, c indicates curvature (1/r), k indicates a conic constant, r indicates a radius of curvature, C indicates vertex curvature, x and y indicate distances from the optical axis, m and n indicate coefficients of monomial xmyn, and Z indicates a depth (sag) with respect to a surface parallel with a z axis.

As described above, when the lens surface is formed to be a free-curved surface, since a lens having a relatively small effective diameter may be manufactured, a size of the wide angle lens module 100 may be reduced.

TABLE 1

| Surface | | | |
|---|---|---|---|
| number | Coefficient | | |
| S3* | K: −6.097792 | A: 0.752326E−04 | B: −.497405E−04 |
| | C: −.273701E−05 | D: 0.439146E−06 | E: −.120484E−07 |
| S5* | K: 0.270494 | A: 0.740926E−02 | B: −.114002E−02 |
| | C: 0.197673E−03 | D: −.170902E−04 | E: 0.621657E−06 |
| S7* | K: 2.5184E+00 | Y: 6.7719E−03 | X2: 3.0238E−03 |
| | Y2: −2.3797E−03 | X2Y: 9.6116E−04 | Y3: 8.1037E−04 |
| | X4: −6.1463E−03 | X2Y2: −3.6228E−03 | Y4: 4.8531E−03 |
| | X4Y: −1.2917E−03 | X2Y3: −4.5798E−03 | Y5: 2.1135E−03 |
| | X6: 2.8238E−02 | X4Y2: 7.4075E−02 | X2Y4: 3.9778E−02 |
| | Y6: 7.0649E−03 | X8: −6.1493E−02 | X6Y2: −2.4597E−01 |
| | X4Y4: −3.6896E−01 | X2Y6: −2.4597E−01 | Y8: −6.1493E−02 |
| | X10: 1.0651E−01 | X8Y2: 5.3256E−01 | X6Y4: 1.0651E+00 |
| | X4Y6: 1.0651E+00 | X2Y8: 5.3256E−01 | Y10: 1.0651E−01 |
| S9** | K: −4.2359E−01 | Y: 1.4537E−02 | X2: 1.9750E−01 |
| | Y2: 1.8138E−01 | X2Y: −8.5111E−04 | Y3: −1.9315E−03 |
| | X4: 5.4994E−02 | X2Y2: 1.0529E−01 | Y4: 4.9546E−02 |
| | X4Y: 1.1016E−03 | X2Y3: 1.8480E−03 | Y5: 2.1168E−03 |
| | X6: −1.4340E−03 | X4Y2: −1.7685E−03 | X2Y4: −3.7077E−03 |
| | Y6: 7.0011E−04 | X8: 1.5208E−03 | X6Y2: 6.0832E−03 |
| | X4Y4: 9.1249E−03 | X2Y6: 6.0832E−03 | Y8: 1.5208E−03 |
| | X10: 7.0306E−04 | X8Y2: 3.5153E−03 | X6Y4: 7.0306E−03 |
| | X4Y6: 7.0306E−03 | X2Y8: 3.5153E−03 | Y10: 7.0306E−04 |

The third lens 130 may be a reflection lens or a prism lens. To this end, the third lens 130 may have at least one second reflection surface S8. The second reflection surface S8 may reflect light incident through the first surface S7 to the second surface S9. Here, the second reflection surface S8 may be formed by coating one surface of the third lens 130 with a material reflecting light.

Meanwhile, although not shown in FIG. 1, an iris may be disposed between the second and third lenses 120 and 130. However, the iris is not limited to being disposed between the second and third lenses 120 and 130, but may be disposed between the first and second lenses 110 and 120 or on other positions, as needed.

The filter member 140 may be disposed behind the third lens 130, based on the subject, which is an object to be imaged.

The filter member 140 may be an infrared (IR) filter blocking IR and formed of glass. Meanwhile, although the case in which the filter member 140 is included in the wide angle lens module 100 is shown in the present embodiment, the filter member 140 may be included in an image sensor module 200. For example, the filter member 140 may be formed integrally with the image sensor module 200.

In the wide angle lens module 100 configured as described above, properties of each of the lenses 110, 120, and 130 are shown in Table 2.

TABLE 2

| | | Radius of | | |
|---|---|---|---|---|
| Surface | | curvature | Thickness | Glass |
| No | Shape of Surface | (mm) | (mm) | code |
| S1 | Spherical surface | 23.92398 | 0.45 | 620.603 |
| S2 | Spherical surface | 4.05182 | 4 | |
| S3* | Aspheric surface | −4.52457 | 4.93 | SP1516′ |
| S4 | Spherical surface | Infinity | 4.93 | |
| S5* | Aspheric surface | −4.44543 | 3.32 | |
| 6(Stop) | | | 0.17 | |
| S7** | Free-curved surface | 3.9022 | 1.8 | ‘F52R’ |
| S8 | Spherical surface | Infinity | 1.8 | |
| S9** | Free-curved surface | −1.61411 | 0.1 | |
| S10 | Spherical surface | Infinity | 0.85 | D263′ |
| S11 | Spherical surface | Infinity | 1.44 | |

As shown in Table 2, in the wide angle lens module 100, both of the surfaces of the first lens 110 are spherical surfaces, both of the surfaces of the second lens 120 are aspheric surfaces, and both of the surfaces of the third lens 130 are free-curved surfaces.

Meanwhile, in the wide angle lens module 100, a size of the first reflection surface S4 may satisfy Equation 3.

$$T 1 > \frac{( A 1 + d 1 * 0.1 )}{0.76} \qquad [ Equation 3 ]$$

Here, T1 indicates a size of the first reflection surface, A1 indicates a size of the first surface S3 of the second lens, and d1 indicates a distance from the first surface S3 of the second lens to the first reflection surface S4.

In addition, an optical axis C1 of the first lens 110, the first reflection surface S4, and the second reflection surface S8 may satisfy Equation 4 with respect to a horizontal surface P perpendicular to an image-formation surface as shown in FIG. 2.

Θ1/2=(Θ2+Θ3) [Equation 4]

Here, Θ1 indicates an angle between the optical axis of the first lens and the horizontal surface P vertical to the image-formation surface (or an image surface of the image sensor module), Θ2 indicates an angle between the first reflection surface and the horizontal surface P vertical to the image-formation surface, and Θ3 indicates an angle between the second reflection surface and the horizontal surface P vertical to the image-formation surface.

Meanwhile, Θ1 may be 35 degrees or more and Θ2 may be an angle of 55 degrees or more with respect to the horizontal surface provided vertically with respect to the image-formation surface. These numerical conditions may be effective in totally reflecting effective incident light incident through the first lens 110 to the second reflection surface S8.

The wide angle lens module 100 satisfying Equations 3 and 4 may effectively image effective portions of the rear of the vehicle (for example, a road under the vehicle in addition to a bumper of the vehicle) in a state in which the wide angle lens module 100 is mounted in the vehicle.

As described above, the wide angle lens module 100 including a plurality of reflection lenses and satisfying the foregoing Equations may provide a relatively stable modulation transfer function (MTF) curve as shown in FIG. 3. Further, since the wide angle lens module 100 has a positive value on a central portion of the optical axis, but becomes to have a negative value toward the surrounding thereof as shown in FIG. 4; distortion phenomenon, a defect in the wide angle lens module, may be significantly reduced.

A rear view camera according to an embodiment of the present invention will be described with reference to FIGS. 5 and 6.

The rear view camera 1000 according to the embodiment of the present invention may include a wide angle lens module 100, an image sensor module 200, and a housing 300. For reference, since configurations of the wide angle lens module 100 are the same as or similar to those of the foregoing wide angle lens module, a detailed description thereof will be omitted.

The image sensor module 200 may convert images incident through lenses 110, 120, and 130 into electrical signals. To this end, the image sensor module 200 may include a plurality of photo sensors and be formed in a charge coupled device (CCD) or complementary metal-oxide semiconductor (CMOS) type.

The housing 300 may receive the wide angle lens module 100 and the image sensor module 200. To this end, the housing 300 may have a space in which the wide angle lens module 100 and the image sensor module 200 are received.

The housing 300 may have a plurality of opened surfaces 310 and 320. The plurality of lenses 110, 120, and 130 and the image sensor module 200 may be mounted through the opened surfaces 310 and 320, respectively.

The first and second opened surfaces 310 and 320 may not be in parallel with each other. For example, the first and second opened surfaces 310 and 320 may form a predetermined angle. More specifically, the first and second opened surfaces 310 and 320 may form an angle the same as or similar to Θ1. Here, the first lens 110 may be mounted on the first opened surface 310, and the image sensor module 200 may be mounted on the second opened surface 320.

In the rear view camera 1000 configured as described above, since a structure in which the wide angle lens module 100 and the image sensor module 200 are disposed is determined by the housing 300, effective portions of the rear of the vehicle may be effectively imaged without using a separate bracket.

As set forth above, according to the embodiments of the present invention, the wide angle lens and the rear view camera having the same may be manufactured at a low cost.

In addition, according to the embodiments of the present invention, since a separate member such as a bracket is not required, it may be easy to install the rear view camera regardless of the design of the vehicle.

While the present invention has been shown and described in connection with the embodiments thereof, it will be apparent to those skilled in the art that modifications and variations can be made without departing from the spirit and scope of the invention as defined by the appended claims.

What is claimed is:

1. A wide angle lens module comprising:
a first lens having negative refractive power;
a second lens having positive refractive power and at least one first reflection surface; and
a third lens having the positive refractive power and at least one second reflection surface.

2. The wide angle lens module of claim 1, wherein the first lens is formed of glass.

3. The wide angle lens module of claim 1, wherein an object-side surface of the first lens is convex, and an image-side surface of the second lens is concave.

4. The wide angle lens module of claim 1, wherein the image-side surface of the second lens is convex.

5. The wide angle lens module of claim 1, wherein the first reflection surface forms an angle of 55 degrees or more relative to a horizontal surface provided vertically with respect to an image-formation surface.

6. The wide angle lens module of claim 1, wherein the first reflection surface satisfies Conditional Equation 1,
T1>(A1+d1*0.1)/0.76, Conditional Equation 1:
where T1 indicates a size of the first reflection surface, A1 indicates a size of a first surface of the second lens, and d1 indicates a distance from the first surface of the second lens to the first reflection surface.

7. The wide angle lens module of claim 1, wherein an image-side surface of the third lens is convex in the vicinity of an optical axis and becomes concave away from the optical axis.

8. The wide angle lens module of claim 1, wherein at least one of an object-side surface and an image-side surface of the third lens is a free-curved surface.

9. The wide angle lens module of claim 1, wherein the first, second, and third lenses satisfy Conditional Equation 2,
Θ1/2=(Θ2+Θ3) Conditional Equation 2:
where Θ1 indicates an angle between an optical axis of the first lens and a horizontal surface provided vertically with respect to an image-formation surface, Θ2 indicates an angle between the first reflection surface and the horizontal surface provided vertically with respect to the image-formation surface, and Θ3 indicates an angle between the second reflection surface and the horizontal surface provided vertically with respect to the image-formation surface.

10. The wide angle lens module of claim 9, wherein Θ1 is 35 degrees or more, and Θ2 is 55 degrees or more.

11. A rear view camera comprising:
a wide angle lens module including at least one reflection lens;
an image sensor module converting images incident through the wide angle lens module into electrical signals; and
a housing receiving the wide angle lens module and the image sensor module and having first and second opened surfaces provided in a non-parallel manner.

12. The rear view camera of claim 11, wherein the lens module includes:
a first lens having negative refractive power;
a second lens including at least one first reflection surface; and
a third lens including at least one second reflection surface.

13. The rear view camera of claim 12, wherein the first lens is mounted on the first opened surface, and the image sensor module is mounted on the second opened surface.

14. The rear view camera of claim 12, wherein the first lens is formed of glass.

15. The rear view camera of claim 12, wherein an object-side surface of the first lens is convex, and an image-side surface of the second lens is concave.

16. The rear view camera of claim 12, wherein the image-side surface of the second lens is convex.

17. The rear view camera of claim 12, wherein the first reflection surface forms an angle of 55 degrees or more relative to a horizontal surface provided vertically with respect to an image-formation surface.

18. The rear view camera of claim 12, wherein the first reflection surface satisfies Conditional Equation 1,
T1>(A1+d1*0.1)/0.76 Conditional Equation 1:
where T1 indicates a size of the first reflection surface, A1 indicates a size of a first surface of the second lens, and d1 indicates a distance from the first surface of the second lens to the first reflection surface.

19. The rear view camera of claim 12, wherein an image-side surface of the third lens is convex in the vicinity of an optical axis and becomes concave away from the optical axis.

20. The rear view camera of claim 12, wherein at least one of an object-side surface and the image-side surface of the third lens is a free-curved surface.

21. The rear view camera of claim 12, wherein the first, second, and third lenses satisfy Conditional Equation 2.
Θ1/2=(Θ2+Θ3) Conditional Equation 2:
where Θ1 indicates an angle between an optical axis of the first lens and a horizontal surface provided vertically with respect to an image-formation surface, Θ2 indicates an angle between the first reflection surface and the horizontal surface provided vertically with respect to the image-formation surface, and Θ3 indicates an angle between the second reflection surface and the horizontal surface provided vertically with respect to the image-formation surface.

22. The rear view camera of claim 21, wherein Θ1 is 35 degrees or more, and Θ2 is 55 degrees or more.
